(19) United States
(12) Patent Application Publication
(10) Pub. No.: US 2014/0299416 A1
(43) Pub. Date: Oct. 9, 2014

(54) LIFT SYSTEM

(71) Applicant: Acorn Mobility Services Limited, Bradford West Yorkshire (GB)

(72) Inventor: John Stewart Jakes, Monaco (MC)

(21) Appl. No.: 14/354,369

(22) PCT Filed: Oct. 17, 2012
(86) PCT No.: PCT/GB2012/052569

§ 371 Date: Apr. 25, 2014

(30) Foreign Application Priority Data
Oct. 26, 2011 (GB) 1118511.3

(51) Int. Cl. B66B 9/08

(52) U.S. Cl. CPC B66B 9/0838
USPC 187/201

(57) ABSTRACT

The present invention provides a lift system comprising a rail; a carriage assembly comprising a seat or platform for supporting a person to be conveyed along the rail; and drive means coupled to the carriage assembly and adapted to engage the rail and drive the carriage assembly along the rail. The lift system my optionally include a levelling means operable to adjust an orientation of the carriage assembly with respect to the rail, a control means arranged to control the drive means, a slope indicating means and/or a curvature indicating means.

### FIELD OF THE INVENTION

The present invention relates to lift systems of the type which comprise a rail (or track) and a seat or platform for supporting a person to be conveyed along the rail. In particular, although not exclusively, the present invention relates to lift systems commonly referred to in the art as stair lift systems, where the rail is typically installed to convey a person from one position, for example at the base of one or more flights of stairs, to a second position at a different height, for example at the top of one or more flights of stairs.

### BACKGROUND TO THE INVENTION

A variety of lift systems of the type typically referred to as stair lifts or stair lift systems are known. These include systems in which a single, straight rail is fixed with respect to a single flight of stairs and a seat is coupled to the rail such that the seat base remains horizontal as the seat travels up and down the rail. In such systems, the angle of inclination of the rail with respect to vertical is constant, and the seat has a fixed orientation with respect to the rail; there is no need to adjust the inclination of the seat with respect to vertical as the seat travels along the rail.

In other known stair lift systems the rail may be required to follow a more complicated path, for example a path involving inclined sections, flat sections, transitional sections in which an inclination changes from one value to another, curved sections in which the track curves in either a horizontal or vertical plane, and compound curved sections (such as helical sections) in which the track simultaneously curves about horizontal and vertical axis (i.e. the projections of the track path onto a horizontal plane and a vertical plane are both curved). These compound curved sections of track can also be described as sections of track in which the direction of the track in the horizontal plane and the height of the track in the vertical direction are both changing at the same time.

These more-complex rail geometries pose problems. Clearly, if the track inclination is varying along a path, then if they seat inclination is fixed with respect of the track the seat inclination with respect to horizontal will also vary as the seat in conveyed along the rail. Also, speeds considered appropriate for conveying a person along one section of track may not be appropriate for other sections. For example, a speed appropriate for conveying a person along a straight section of track may be, or feel, too slow or too fast when the person is being conveyed around a curved section, depending on whether the person on the seat is facing inwardly or outwardly as the seat negotiates the respective curve. Additionally, it may be appropriate to convey the seat at different speeds, dependent upon the degree of the inclination of a track section.

Thus, it is known that it may be desirable to convey a seat along the rail of a stair lift system at a speed which is dependent on the position along the rail. In certain known systems, the stair lift has required programming after installation, with an installation engineer manually programming in a plurality of different fixed speeds for driving the seat along the rail, each speed being set for a respective section of the rail. Disadvantages with this approach are that the programming is time consuming, the stair lift control means requires means for programming in these values and memory means for storing the programmed speeds as a function of position along the rail. This makes the system more complex and more expensive, and there is always the possibility that the memory means over time may become corrupted, damaged, or wiped entirely, each of these outcomes having its own associated further disadvantages.

With regard to the problem of keeping the seat level along a rail following a complicated path (i.e. not just a straight path of constant inclination) mechanical systems for maintaining the seat level have been proposed, but typically these increase the complexity, weight, and cost of the stair lift system as a whole.

Another attempted solution is disclosed in EP 1772412 A1. That document discloses a stair lift with angular positioning means comprising a carriage which can move, by way of transfer motor means, along a rail which connects at least two points with variation in level along the path, a supporting structure being connected to the carriage by way or angular variation motor means with the possibility to rotate about a substantially horizontal axis, the stair lift further comprising an automatic balancing unit adapted to self-learn the parameters of the length of the path and of the portions of the variation of inclination of the path in order to control the travel speed provided by transfer motor means, the angular variation motor means being controlled by an angular variation sensor. The carriage of the disclosed system does not remain level, but instead its inclination varies as it travels along the rail. In other words, the carriage inclination follows the rail. The disclosed system requires programming before use. After installing the rail, the stair lift is made to travel along the rail from one end to the other, and during this first run the inclinometer records every variation in the slope of the support structure (or seat) with respect to vertical (or equivalently with respect to the horizontal). At the end of the initial self-learning step, the system has mapped the entire path and has determined the portions where the balancing system must intervene. A disadvantage of this system is that it requires this initial programming run after installation, which of course consumes time, requires a more sophisticated control system able to “learn” from this initial run, and furthermore requires memory to store data indicative of the mapped path. A problem again is that the stored data may become corrupted or lost over time. The system is reliant on correct data to indicate portions of rail where the balancing system must intervene. Thus, under fault conditions there is potential for seat inclination to be incorrectly set.

Document WO99/29611 discloses a stair lift comprising a carriage, displaceable along a bent path, and a chair (which may also be described as a seat) carried by the carriage and mounted on the carriage for tilting about a horizontal axis of rotation. The system also comprises a horizontal keeping mechanism for keeping the chair upright (i.e. for maintaining the seat upright), this mechanism comprising an angle sensor providing a signal indicative of the instantaneous value of an angle of rotation between the chair and the carriage, an orientation sensor associated with the carriage and providing a signal indicative of variations in the position in the carriage, and an absolute-orientation sensor associated with the chair providing a signal representative of the instantaneous value of the position of the chair. Again, the disclosed system comprises a carriage whose inclination follows that of the rail. The document discloses that the absolute-orientation sensor may be a gravitational direction sensor, and the document also discloses that for the absolute-orientation sensor, accuracy is more important than speed. In this system a mechanism is employed to adjust the angle of the chair with respect to the carriage. A disadvantage with the disclosed system is that it requires at least three sensors to provide the levelling function, namely the angle sensor providing a signal indicative of the instantaneous value of the angle of rotation between the chair and the carriage, the orientation sensor providing a signal indicative of the inclination of the carriage with respect to vertical, and at least one absolute-orientation sensor providing a signal indicative of the inclination of the chair with respect to vertical (or equivalently with respect to the horizontal). Clearly, the greater the number of sensors required on the system the greater the complexity and cost, and the greater the potential problem with reliability.

### SUMMARY OF THE INVENTION

It is an aim of embodiments of the invention to provide a lift system which solves, at least partly, one or more of the problems associated with the prior art.

According to a first aspect of the invention there is provided a lift system comprising:
a rail (which may also be described as a track):
a carriage assembly comprising a seat or platform for supporting a person to be conveyed along the rail;
drive means coupled to the carriage assembly and adapted to engage the rail and drive the carriage assembly along the rail; and
levelling means operable to adjust an orientation of the carriage assembly with respect to the rail (for example about at least a first axis),
the carriage assembly further comprising:
a first accelerometer arranged to provide an output signal indicative of an inclination of the seat or platform with respect to a horizontal plane (comment: or, equivalently, to a vertical axis) ; and
control means arranged to receive said output signal and adapted to control the levelling means in response to the output signal to adjust said orientation to maintain the inclination of the seat or platform substantially at a predetermined value or within a predetermined range as the carriage is conveyed along the rail.

Thus, the seat or platform is integral to the carriage assembly, and the control means is arranged to maintain the inclination of the seat or platform of the carriage assembly substantially at a predetermined value or within their predetermined range (for example to keep the seat substantially horizontal, that is at 0° with respect to horizontal, plus or minus a certain tolerance, such as 1, 2, 3, 4, or 5 degrees, depending on application).

Advantageously, the carriage assembly utilises a first accelerometer for this level control. This may be an accelerometer selected to have high sensitivity, providing an output signal in the form of an output voltage which can be used to maintain the seat at a desired orientation with high accuracy. The accelerometer in certain embodiments is a device which measures the proper acceleration of the device, that is the acceleration associated with the phenomenon of weight experienced by a test mass that resides in the frame of reference of the accelerometer device. Types of accelerometer which may be used as the first accelerometer in embodiments of the invention include electronic accelerometers, such as piezoelectric, piezoresistive and capacitive accelerometers. These accelerometers may be, or incorporate, small micro electro-mechanical systems (MEMS).

By utilising the first accelerometer and levelling means under the control of the control means, the lift system according to this first aspect of the invention is able to provide real-time levelling, that is the system is able to keep the seat level as the carriage assembly is driven along the rail, irrespective of variations in inclination of the rail, without having to be pre-programmed or require a memory. This self-levelling in real-time can be achieved by using just one relatively inexpensive sensor in the form of the first accelerometer.

In certain embodiments the levelling means is coupled to the carriage assembly and adapted to engage the rail.

In certain embodiments the accelerometer output signal is an output voltage.

In certain embodiments the accelerometer is rigidly mounted in the carriage assembly. Thus the accelerometer may be rigidly and securely mounted with respect to the seat or platform of the carriage assembly such that its output signal can be used to give a reliable and accurate indication of seat or platform inclination. A high sensitivity accelerometer may be used. In general, its output signal will be noisy, containing a component indicative of instantaneous tilt of the accelerometer (a low frequency component) and a high frequency component corresponding to high frequency acceleration of the accelerometer resulting from mechanical vibration or jitter as the carriage travels along the rail. For example, the accelerometer may be sensitive enough such that its output signal comprises components resulting from rotation of a drive motor, interaction between a drive pinion and a rack, and motion of one or more support rollers or guide rollers or wheels of a levelling bogie or drive bogie over joints between rail sections. The accelerometer output signal with these relatively high-frequency components may be suitably processed to yield a signal accurately indicative of instantaneous seat or platform inclination.

In certain embodiments the levelling means comprises a levelling motor operable to adjust said orientation, and the levelling means may further comprise a levelling mechanism driven by the levelling motor to adjust said orientation. The control means in certain embodiments is arranged to use the accelerometer output signal to generate a controller output signal, and to supply said controller output signal to the levelling motor to control said motor. In such embodiments the levelling motor may comprise a rotor and a stator, and the controller output signal may be arranged to control a speed and direction of rotation of the rotor.

In certain embodiments the control means is arranged to filter the accelerometer output signal and use the filtered signal to generate the controller output signal.

In certain embodiments the control means is arranged to sample the accelerometer output signal to yield a plurality of sampled values (S₁, S₂, . . . Sₙ where n is an integer) and the control means is further arranged to use the sampled values to generate the controller output signal.

In certain embodiments the control means is arranged to sample the accelerometer output signal at a rate of R samples per second, where R is in the range 500 to 2000, and preferably 1000.

In certain embodiments the control means is arranged to generate a plurality of average values (A₁, A₂, . . . Aₘ where m is an integer) from the sampled values, each average value being a value obtained by averaging a respective plurality of the sampled values, the control means being arranged to use the average values to generate the controller output signal.

In certain embodiments each average value is obtained by averaging X sampled values, where X is in the range 20 to 100, and preferably 64. This averaging process is advantageous in that it helps reject the relatively high frequency components of the accelerometer output signal which are not indicative of seat inclination, but instead result from motion of the carriage assembly along the rail and movement and interaction of components of the system as the carriage is conveyed along the rail. In certain embodiments each average value obtained from the sampled output values is used as an indication of seat inclination in a suitable levelling means control algorithm.

In certain embodiments the control means is arranged to compare each average value with a first threshold value and with a second threshold value in the process of using the average values to generate the controller output signal.

In certain embodiments the control means is arranged to use a said average value as an indication of inclination if that average value lies outside the range defined by the first and second threshold values.

In certain embodiments the control means is arranged to treat said inclination as being equal to a predetermined constant if that average value lies within said range.

In certain embodiments the control means is adapted to generate the control output signal using a cyclical algorithm having an input parameter, and the control means is adapted to set the input parameter in each cycle of the algorithm to equal the average value corresponding to that cycle if that average value lies outside the range defined by the first and second thresholds, and to equal a constant value (i.e. a predetermined constant) if that average value lies inside said range. Thus, once the average value of accelerometer output signal has fallen within the predetermined range, indicating that the seat or platform inclination is within a certain range of the desired value, the input parameter ceases changing and this helps the levelling system settle.

In certain embodiments the algorithm is a PID algorithm, the control output signal comprising a first component, proportional to a current error value, a second component, derived from at least one previous error value, and a third component, dependent upon a rate of change of error value, wherein the error value in a particular cycle is equal to the difference between a constant, indicative of a desired inclination, and the average value corresponding to that cycle if that average value lies outside the range defined by the first and second thresholds, and the error value equals zero if that average value lies inside said range.

In certain embodiments the control means is arranged to control the drive means, and the carriage assembly comprises a second accelerometer arranged to provide a second output signal indicative of said inclination, the control means being arranged to receive said second accelerometer output signal and being adapted to use the first and second accelerometer output signals to determine whether or not to control the drive means to drive the carriage assembly along the rail. In other words, the second accelerometer may be used as a safety-check the control means may be ranged to perform some comparison, on the basis of the output signals from the first accelerometer and the second accelerometer and, based on that comparison, decide whether or not to commit or inhibit the carriage assembly from being conveyed along the rail. For example, if the output signals from the two accelerometers differ widely, this is likely to be indicative of a fault with at least one of the accelerometers. Under these conditions, it is not safe for the control means to permit the carriage assembly to be driven along the rail.

In certain embodiments the control means is arranged to sample the second accelerometer output signal to yield a plurality of second sampled values.

In certain embodiments the control means is arranged to sample the second accelerometer output signal at a lower rate than the first accelerometer output signal.

Generally, it is advantageous to sample the first accelerometer output at a high rate to enable averaging to be used to reject relatively high frequency noise and yield a signal actively indicative of seat orientation. The higher the sampling rate, however, the greater the amount of processing required by the control unit and the greater the power consumption. Advantageously, therefore, in certain embodiments the second accelerometer output is sampled at a lower rate. This may be adequate for safety control purposes, and reduces power consumption complied with a system in which both accelerometers are sampled at the same rate.

In certain embodiments the control means is arranged to sample the second accelerometer output signal at a rate of R2 samples per second, where R2 is in the range 50 to 200, and preferably 100.

In certain embodiments the control means is arranged to generate a second average value from the second sampled values, the second average value being a value obtained by averaging a respective plurality of the second sampled values, the control means being arranged to compare the second average value with an average value obtained from the first accelerometer output signal and to prevent the drive means from driving the carriage assembly along the rail if the compared values differ by more than a predetermined amount.

In certain embodiments the second average value is obtained by averaging Y sampled values, where Y is in the range 20 to 100, and preferably 64.

In certain embodiments the control means is arranged to control the drive means, and the system further comprises at least one of:
slope indicating means arranged to provide the control means with at least one signal (which may be described as a slope indicating signal) indicative of a slope of a portion of rail on which the carriage assembly is currently located; and
curvature indicating means arranged to provide the control means with at least one signal (curvature indicating signal) indicative of a horizontal component of curvature (e.g. about a vertical axis, or equivalently in a horizontal plane) of the portion of the rail on which the carriage assembly is currently located,
and wherein the control means is adapted to use at least one of said signals indicative of slope or curvature to control a speed at which the drive means drives the carriage assembly along the rail according to position (i.e. of the carriage assembly) along the rail.

Advantageously, such systems are able to provide real-time control of drive speed along the track and real-time seat or platform levelling, fully responsive to changes in track inclination and/or changes in track direction (changes in the horizontal compenent of track direction) and without requiring any pre-programming or memory to store data acquired or programmed in a post-installation set-up procedure.

In certain embodiments the slope and curvature signals may entirely determine the speed, as a function of rail position, which the carriage means is driven along the rail in response to a user input (by means of a control switch or joystick arrangement, for example). However, in alternative embodiments the user may have a degree of control over speed, subject to restrictions determined by the slope and/or curvature indicating means

In certain embodiments the control means is adapted to use at least one of said signals indicative of slope or curvature to determine a maximum speed at which the drive means may drive the carriage assembly along the rail according to position along the rail.

In certain embodiments the control means is adapted to use at least one of said signals indicative of slope or curvature to determine a window of speeds at which the drive means may drive the carriage assembly along the rail according to position along the rail.

In certain embodiments the system comprises both said slope indicating means and said curvature indicating means, and the control means is adapted to use at least one of said signals indicative of slope and at least one of said signals indicative of curvature to control the speed at which the drive means drives the carriage assembly along the rail according to position along the rail.

In certain embodiments the levelling means comprises:
a support roller adapted to engage the rail and support the carriage assembly on the rail; and
means for adjusting a vertical position of the support roller relative to the carriage assembly,
and wherein the at least one signal indicative of a slope comprises at least one signal indicative of the vertical position of the support roller relative to the carriage assembly.

In certain embodiments the slope indicating means may be relatively sophisticated, providing an output signal which varies continuously with support role or vertical position over at least a range of positions. However, in alternative embodiments a simpler slope indicating means may be provided. For example, in one simple arrangement, a single such switch is utilised having a first state when the support role in position is within a certain range of its “level rail position”, and a second state when the support roller is outside that range. Even though this is a relatively crude indicator of track inclination, it may be adequate for certain purposes, for example in providing a two-speed drive control, where the carriage may be driven at a first, higher speed when the track is relatively level, and a second, lower speed when the track is inclined by more than a certain, predetermined amount. As will be appreciated, an increasingly sophisticated speed control system may be implemented by incorporating additional switches to detect support roller height, to give speed control which is able to select between a greater number of discrete values.

Advantageously, additional safety may be provided by arranging a switch or other sensor to detect when the levelling support roller is in the “level rail position”, and arranging the controller such that it will only permit driving of the carriage assembly at its high speed (i.e. maximum speed) when this signal from the sensor is detected. In other words, if the sensor arranged to detect “level track position” fails, then carriage speed along the track is restricted to the lower value or values.

In certain embodiments the slope indicating means comprises at least one switch having a state dependent upon the vertical position of the support roller relative to the carriage assembly.

In certain embodiments the system further comprises a levelling bogie assembly pivotally coupled to the carriage assembly such that the levelling bogie assembly can rotate about a first vertical axis, relative to the carriage assembly, when the seat or platform is horizontal, the levelling bogie assembly comprising the levelling means and being adapted to engage the rail such that a rotational position of the levelling bogie assembly about the first vertical axis relative to the carriage assembly is dependent upon the curvature, about a vertical axis, of the portion of rail on which the carriage assembly is currently located, and wherein the at least one signal indicative of curvature comprises at least one signal indicative of the rotational position of the levelling bogie assembly about the first vertical axis relative to the carriage assembly.

In such embodiments, the curvature indicating means may comprise a sensor (e.g. a switch, or a more complicated arrangement) responsive to the angular position of the levelling bogie assembly to generate a rail curvature signal. Again, this sensor may be relatively sophisticated, providing indication of a range of angular positions of the levelling bogie assembly. Alternatively, the sensor may be relatively simple.

In certain embodiments the curvature indicating means comprises at least one switch having a state dependent upon the rotational position of the levelling bogie assembly about the first vertical axis relative to the carriage assembly.

In certain embodiments the system further comprises a drive bogie assembly pivotally coupled to the carriage assembly such that the drive bogie assembly can rotate about a second vertical axis, relative to the carriage assembly, when the seat or platform is horizontal, the drive bogie assembly comprising the drive means and being adapted to engage the rail such that a rotational position of the drive bogie assembly about the second vertical axis relative to the carriage assembly is dependent upon the curvature, about a vertical axis, of the portion of rail on which the carriage assembly is currently located, and wherein the at least one signal indicative of curvature comprises at least one signal indicative of the rotational position of the drive bogie assembly about the second vertical axis relative to the carriage assembly.

As with the levelling bogie assembly, the curvature indicating means may comprise a sensor arranged to detect angular position of the drive bogie assembly. Again, it may be relatively sophisticated, or take a more simple form.

In certain embodiments the curvature indicating means comprises at least one switch having a state dependent upon the rotational position of the drive bogie assembly about the second vertical axis relative to the carriage assembly.

Thus, the rotations of the levelling bogie assembly and/or the drive bogie assembly relative to the carriage about their vertical axes are dependent upon, and therefore are a good indication of, track curvature in (i.e. projected onto) a horizontal plane. Conveniently, therefore, relatively simple detection means may be arranged to respond to these rotations, the output from these detection means being used by the controller to give a graduated speed control (i.e. to provide a track speed which is controlled to vary between a plurality of different predetermined values as the carriage is conveyed along the rail.

It will be appreciated that in certain embodiments, just a single accelerometer is required in order to provide real-time levelling control. With this levelling control in place, instantaneous position of the levelling means support roller can be used as an indication of current rail inclination, and the angular position of one or both of the drive and levelling bogie assemblies can be used as an indication of current track curvature in the horizontal direction, thereby enabling real-time levelling and real-time speed control (responsive to changes in track inclination and curvature) to be achieved simultaneously. No memory is required.

In certain embodiments the rail comprises a toothed rack, and the drive means comprises a toothed pinion adapted to engage the toothed rack.

In certain embodiments the rail comprises a plurality of rail sections connected together.

Another aspect of the invention provides apparatus comprising the carriage assembly, drive means, and levelling means of a lift system in accordance with the first aspect. The apparatus may additionally comprise slope indicating means and curvature indicating means.

Another aspect of the invention provides a method of operating a lift system comprising a rail, a carriage assembly comprising a seat or platform for supporting a person to be conveyed along the rail, drive means coupled to the carriage assembly and adapted to engage the rail and drive the carriage assembly along the rail, and levelling means operable to adjust an orientation of the carriage assembly with respect to the rail, the method comprising:
arranging a first accelerometer in the carriage assembly to provide an output signal to control means, the output signal being indicative of an inclination of the seat or platform with respect to a horizontal plane; and
operating the control means to control the levelling means in response to the output signal to adjust said orientation to maintain the inclination of the seat or platform substantially at a predetermined value or within a predetermined range as the carriage is conveyed along the rail.

Another aspect provides a lift system comprising:
a rail:
a carriage assembly comprising a seat or platform for supporting a person to be conveyed along the rail;
drive means coupled to the carriage assembly and adapted to engage the rail and drive the carriage assembly along the rail;
control means arranged to control the drive means;
slope indicating means arranged to provide the control means with at least one signal indicative of a slope of a portion of the rail on which the carriage assembly is currently located; and
curvature indicating means arranged to provide the control means with at least one signal indicative of a curvature, about a vertical axis, of the portion of the rail on which the carriage assembly is currently located,
and wherein the control means is adapted to use at least one of said signals indicative of slope or curvature to control a speed at which the drive means drives the carriage assembly along the rail according to position along the rail.

Advantageously, the system is therefore able to provide real-time control of carriage assembly drive speed, avoiding the need for pre-programming and a memory, which is responsive to changes in rail inclination and/or curvature. As will be appreciated, features of the lift system in accordance with the first aspect of the invention, and of its embodiments, may be incorporated in embodiments of this further aspect of the invention and provide corresponding advantages. For example, the control means may be adapted to use at least one of said signals indicative of slope or curvature to determine a maximum speed at which the drive means may drive the carriage assembly along the rail according to position along the rail. The control means may be adapted to use at least one of said signals indicative of slope or curvature to determine a window of speeds at which the drive means may drive the carriage assembly along the rail according to position along the rail.

In certain embodiments the system further comprises both said slope indicating means and said curvature indicating means, and the control means is adapted to use at least one of said signals indicative of slope and at least one of said signals indicative of curvature to control the speed at which the drive means drives the carriage assembly along the rail according to position along the rail.

In certain embodiments the system further comprises a drive bogie assembly pivotally coupled to the carriage assembly such that the drive bogie assembly can rotate about a second vertical axis, relative to the carriage assembly, when the seat or platform is horizontal, the drive bogie assembly comprising the drive means and being adapted to engage the rail such that a rotational position of the drive bogie assembly about the second vertical axis relative to the carriage assembly is dependent upon the curvature, about a vertical axis, of the portion of rail on which the carriage assembly is currently located, and wherein the at least one signal indicative of curvature comprises at least one signal indicative of the rotational position of the drive bogie assembly about the second vertical axis relative to the carriage assembly.

In certain embodiments the curvature indicating means comprises at least one switch having a state dependent upon the rotational position of the drive bogie assembly about the second vertical axis relative to the carriage assembly.

In certain embodiments the system further comprises:
levelling means operable to adjust an orientation of the carriage assembly with respect to the rail; and
inclination indicating means arranged to provide an output signal indicative of an inclination of the seat or platform with respect to a horizontal plane,
the control means being arranged to receive said output signal and adapted to control the levelling means in response to the output signal to adjust said orientation to maintain the inclination of the seat or platform substantially at a predetermined value or within a predetermined range as the carriage is conveyed along the rail.

In certain embodiments, the inclination indicating means may comprise accelerometer, such as any accelerometer described above in relation to the first aspect of the invention. However, in alternative embodiments of this aspect, different inclination indicating means may be used.

In certain embodiments the levelling means comprises:
a support roller adapted to engage the rail and support the carriage assembly on the rail; and
means for adjusting a vertical position of the support roller relative to the carriage assembly,
and wherein the at least one signal indicative of a slope comprises at least one signal indicative of the vertical position of the support roller relative to the carriage assembly.

In certain embodiments the slope indicating means comprises at least one switch having a state dependent upon the vertical position of the support roller relative to the carriage assembly.

In certain embodiments the system further comprises a levelling bogie assembly pivotally coupled to the carriage assembly such that the levelling bogie assembly can rotate about a first vertical axis, relative to the carriage assembly, when the seat or platform is horizontal, the levelling bogie assembly comprising the levelling means and being adapted to engage the rail such that a rotational position of the levelling bogie assembly about the first vertical axis relative to the carriage assembly is dependent upon the curvature, about a vertical axis, of the portion of rail on which the carriage assembly is currently located, and wherein the at least one signal indicative of curvature comprises at least one signal indicative of the rotational position of the levelling bogie assembly about the first vertical axis relative to the carriage assembly.

In certain embodiments the curvature indicating means comprises at least one switch having a state dependent upon the rotational position of the levelling bogie assembly about the first vertical axis relative to the carriage assembly.

### BRIEF DESCRIPTION OF THE DRAWINGS

Embodiments of the invention will now be described with reference to the accompanying drawings of which:

FIG. 1 is a schematic representation of part of a lift system embodying the invention, with the carriage assembly located on an inclined section of rail;

FIG. 2 is a schematic representation of part of the lift system of the first embodiments, with the carriage assembly positioned on a substantially level section of rail;

FIG. 3 is a schematic view from above of the first embodiment, with the carriage assembly located on a substantially straight section of rail;

FIG. 4 is a schematic representation from above of the first embodiment with the carriage assembly located on a curved section of rail;

FIG. 5 is a schematic view from above of the first embodiment with the carriage assembly located on another curved section of rail;

FIG. 6 is a schematic view of component of a levelling bogie assembly of a stair lift embodying the invention;

FIG. 7 is a schematic view of part of another system embodying the invention;

FIG. 8 is a drawing of a level bogie assembly of an embodiment of the invention;

FIG. 9 is a drawing of a power bogie assembly of an embodiment of the invention;

FIG. 10 is a drawing of part of a lift system incorporating the levelling and power bogie assemblies of FIGS. 8 and 9, the carriage assembly being located on a substantially level section of rail;

FIG. 11 is a drawing of the embodiment of FIG. 10, with the carriage assembly being located on an inclined section of rail; and

FIG. 12 is a photograph of part of another embodiment of the invention, showing articulation of the power and drive bogies relative to the carriage assembly to negotiate a horizontal bend or curve.

### DETAILED DESCRIPTION OF EMBODIMENTS OF THE INVENTION

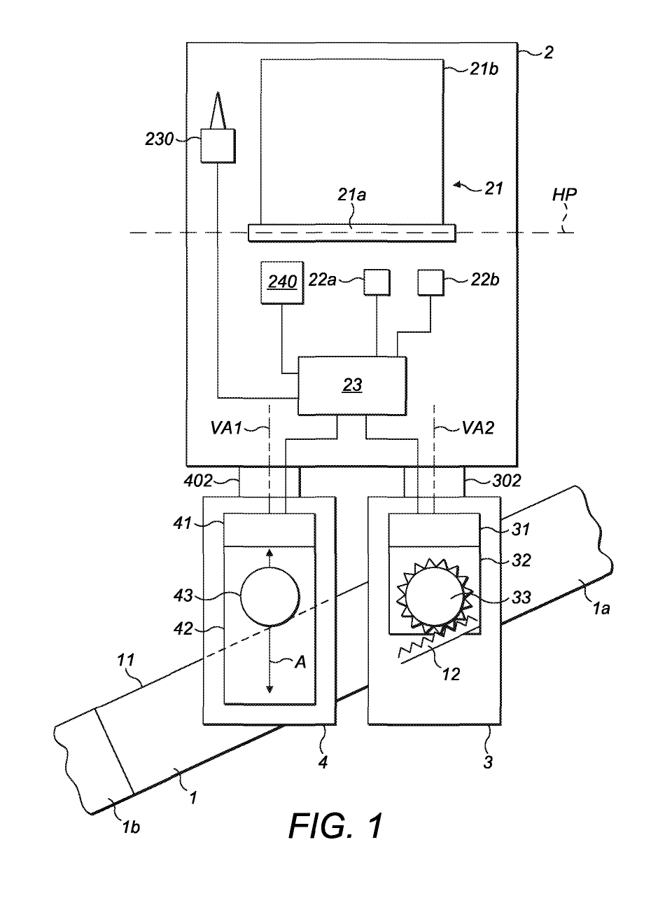

Referring now to FIG. 1, this is a schematic representation of part of a stairlift system embodying the invention. The system comprises a rail (1) which is sectional, and part of two of those sections 1a and 1b are shown in the figure. The system also comprises a carriage assembly (2) comprising a seat (21) which itself comprises a seat base (21a) and a seat back (21b). In use, a person sits on the seat base (21a) and has their back supported by the seat back (21b) as the carriage assembly (2) is controlled to move up or down rail (1). The carriage assembly (2), which may also be described as a carriage, also comprises a first accelerometer (22a) and a second accelerometer (22b), each arranged to provide a respective output signal indicative of an inclination of the seat or platform with respect to a horizontal plane, HP. In the figure the seat base (21a) is substantially horizontal, such that the inclination of the seat base to the plane HP is substantially zero. The two accelerometers (22a, 22b) are highly sensitive to acceleration of the carriage assembly, in which they are rigidly mounted, and their output signals comprise components indicative of tilt of the carriage assembly and also relatively high frequency components arising from the motion of the carriage assembly along the rail. The carriage assembly (2) also comprises a controller (23) arranged to receive the output signals from the accelerometers, a battery (240) and input means (230) in the form of a joystick which the user can operate so as to control the carriage assembly to be conveyed along the rail. Although a joystick is employed in this embodiment, it will be appreciated that other forms of input means may be employed in alternative embodiments. The controller (23) receives the output signal from the input means (230). The system also comprises a drive bogie assembly (3) which is rotationally coupled to the carriage assembly (2) by means of rotational coupling (302). This coupling (302) is arranged such that the drive bogie assembly (3) is able to rotate about a fixed axis relative to the carriage assembly in order to negotiate bends in the rail. In the figure, the carriage assembly is arranged with the seat base substantially level, such that the axis about which the drive bogie assembly (3) can rotate is vertical, and this axis is referred to as the second vertical axis, VA2, in the accompanying claims. The drive bogie assembly (3) comprises drive means coupled to the carriage assembly (2) and adapted to engage the rail (1) and drive the carriage the assembly along the rail. The drive means comprises a drive motor (31) controlled by the controller (23), a toothed-drive pinion (33) arranged to engage a correspondingly toothed rack (12) of the rail (1), and a drive mechanism (32), such as a gearbox, arranged to convert rotation of the drive motor rotor into rotation of the toothed pinion (33) to drive the carriage assembly along the rail. The control single from the controller (23) to the drive motor (31) controls both the direction and speed and rotation of the drive motor rotor relative to its stator. Although not shown in FIG. 1, the drive bogie assembly (3) may also comprise one or more support and/or guide rollers arranged to engage corresponding surfaces of the rail to support and/or guide the drive bogie assembly along the rail that the carriage assembly (2) is conveyed. As will be appreciated, a bogie may generally be described as an assembly comprising one or more wheels or rollers and forms a pivoted support.

The system also comprises a levelling bogie assembly (4) which is also rotationally coupled to the carriage assembly (2) by means of a rotational coupling (402), such that the levelling bogie assembly can rotate about another fixed axis. In the position illustrated in FIG. 1, with the seat base horizontal, this axis about which the level bogie assembly (4) can rotate is a first vertical axis VA1, this axis being parallel to the vertical axis VA2 about which the drive bogie assembly can rotate. Again, as for the drive bogie assembly (which may also be referred to as a drive or power bogie) the rotational coupling of the level bogie (4) to the carriage assembly enables the level bogie to maintain its engagement with the rail and rotate about axis VA1 as the carriage assembly is conveyed around curved portions of the rail. The level bogie (4) comprises levelling means operable to adjust the orientation of the carriage assembly with respect to the rail. This levelling means comprises a levelling motor (41) under control of the controller (23), a support wheel (43) adapted to engage a support surface (11) of the rail (1), and a levelling mechanism (42) driven by the levelling motor (41) to adjust the vertical position (i.e. height) of the support wheel (43) relative to the carriage assembly (2). Thus, the levelling motor (41) is controllable to adjust the vertical position of the support (43), via the levelling mechanism (42), generally over the range indicated by arrow A of the figure. As will be appreciated, adjusting the height of the support wheel (43) when the carriage assembly is supported on the rail adjusts the tilt of the seat base with respect to the horizontal. The control means (23) receives the output signal of the first accelerometer (22a) and is adapted to control the levelling means in response to the output signal to adjust the vertical position of the support wheel (43) and so maintain the inclination of the seat base to horizontal substantially at zero degrees, or within a small range around zero degrees, for example plus or minus 5, 4, 3, 2 or 1 degrees.

In this first embodiment the first and second accelerometers (22a, 22b) each produce an output signal in the form of a respective output voltage, that voltage varying with time and comprising relatively low frequency component indicative of tilt of the carriage assembly (2) (and hence the accelerometers themselves) and relatively high frequency components arising from accelerations of the carriage assembly (2) as it moves up and down the rail (1). The controller (23) is generally arranged to process these output signals to filter out the relatively high frequency components. To do this, the controller (23) samples the output voltages to yield a plurality of sampled values, and then generates a plurality of average values from the sample values, each average value being a value obtained by averaging a respectively plurality of the sampled values. In certain embodiments the controller then uses these average values directly as an indication of carriage assembly tilt and controls the levelling means accordingly. In other embodiments, the control means may perform one or more further operations on the average values before using them to generate a control signal for the levelling motor, for example. For example, the controller may first compare an average value to see if it lies between pre-determined limits. If the average value lies outside those limits, then it may be used as an indication of carriage assembly tilt. Alternatively, if it lies within those limits then the carriage assembly tilt may be treated as close enough to zero, and the average value may then be ignored.

The controller (23) is arranged to use the second accelerometer output signal as a safety check. The controller processes the output signals from the two accelerometers, and performs a comparison (for example a comparison between average values obtained from sample values from each output) and if the comparison determines that the output signals differ by too great a degree (e.g. one average value differs from another average value by more than a pre-determined threshold amount) then the controller may inhibit the carriage assembly from being moved or driven along the rail (1).

In this first embodiment, the first accelerometer (22a) which is used for control of the levelling means is sampled at a rate of 1000 Hz, and the second accelerometer (22b) is sampled at a lower rate of 100 Hz.

Further details of how the accelerometer output signals are used to control the levelling means in certain embodiments of the invention are as follows.

In certain embodiments the levelling motor (which may also be described as the tilt motor) is controlled using a PID (proportional-integral-derivative) algorithm. This involves three separate parameters: proportional; integral; and derivative values.

The proportional value is derived from the current “displacement error” (that is the error corresponding to the difference between the desired seat orientation and the current, actual orientation), the integral value is derived from the sum of recent errors, and the derivative value is based on the rate at which the error has been changing. The weighted sum of these three values is used to adjust the speed and direction of the tilt motor.

By tuning the three constants in the PID controller algorithm, the controller can provide control action to suit various angle changes in the lift rail.

The response of the controller can be described in terms of the responsiveness of the controller to an error, the degree to which the controller overshoots the setpoint, and the degree of system oscillation. A motor control signal “Motor speed” may be derived as follows:

Motor speed=Pout+Iout+Dout.

Pout=Position error*Pgain.

If Pgain is too high the result will be continuous over-swing, or system oscillation. If Pgain is too low it will take too long to reach the required position.

Iout=The sum of the errors to date*Igain.

The integral term (when added to the proportional term) accelerates the motor towards the required position and eliminates the residual steady-state error that occurs with a proportional only controller. However, since the integral term is responding to accumulated errors from the past, it can cause the motor to overshoot.

Dout=The slope of the error*Dgain.

The rate of change of the process error is calculated by determining the slope of the error over time and multiplying this rate of change by the derivative gain. The derivative term slows the rate of change of the controller output and this effect is most noticeable close to the required position. Hence, derivative control is used to reduce the magnitude of the overshoot produced by the integral component and improve the combined process stability. However, differentiation of a signal amplifies noise and thus this term in the controller is highly sensitive to noise in the error term, and can cause a process to become unstable if the noise and the derivative gain are sufficiently large.

A simplified software routine for controlling the tilt motor may be as follows:
previous_error=0
integral=0
start:

error=setpoint−actual_position

integral=integral+error*time interval

derivative=(error−previous_error)/time interval

output=Pgain*error+Igain*integral+Dgain*derivative

previous_error=error
wait(time interval)
goto start

In this routine, actual_position may be set to equal the latest average value of accelerometer output signal sampled values if that latest average value is outside pre-set (pre-determined) limits (i.e. outside a predetermined range). If that latest average value lies inside those limits, then actual_position may be set to “setpoint”, such that error=0.

The software may be tuned according to the following method, which involves adjusting the gain values until the performance is satisfactory. The three settings are normally adjusted separately in order to see the effects of the different settings.
1. Set Igain and Dgain to zero.
2. Set the proportional gain, (Pgain) to a low value (2), and enable the controller.
3. Increase the proportional gain by small increments until continuous cycling occurs after a small set-point change.
   The term “continuous cycling” refers to a sustained oscillation with constant amplitude. At first it might be useful to increment Pgain by an order of magnitude (i.e. multiply or divide by 10) just to get in the right area. Then one can consider doubling or dividing by two to get closer.
4. Reduce Pgain by a factor of two.
5. Bring in the integral and decrease the integral time until continuous cycling occurs again. Set integral time to three times this value. Note that because of the way the formulas are constructed, a smaller integral time means a larger integral component.
6. Bring in the derivative and increase derivative time, until continuous cycling occurs. Set derivative time to one-third of this value. Note that because of the way the formulas are constructed, a larger derivative time means a larger derivative component (which is opposite from the effect of changing the integral time).

The proportional gain that results in continuous cycling in Step 3 is called the ultimate gain. In performing the experimental test to find the ultimate gain, it is important that the output does not saturate. If saturation occurs it is possible to get continuous cycling even though the gain is higher than the ultimate gain. This would then result in a too high gain in Step 4.

Further detail is as follows. The design of the lift controller 23 may allow a choice of accelerometers. In certain embodiments the accelerometer device used is the LIS352AR from ST Microelectronics (but it will be appreciated that other embodiments may use different accelerometers). This is a 2-axis accelerometer (X and Y axis, although certain embodiments only use the Y-axis output signal), and it is a rigid attachment to the lift controller board. The output is an analogue value (a voltage) which is a combination of acceleration and tilt components. The output varies quickly to acceleration and slowly to tilt. In order to remove the acceleration part (which generally is not needed for tilt control), the signal is filtered by an averaging routine that takes and sums 64 readings, and then calculates an average value from the result.

This result is compared with a high limit and a low limit, and values in excess of those limits then form the “actual_position” input to the PID algorithm. The high and low limits are dynamic values that are set at the start of each move. This eliminates small changes in values due to any shift in temperature.

If the average value of the set of accelerometer output signal samples is inside the limits then this is a “zero” input into the levelling algorithm. The levelling algorithm does not stop; it continues all the time the lift (carriage) is in motion.

As the lift approaches level, the algorithm produces smaller and smaller level-motor speeds, so that the levelling motor does not over-shoot or vibrate (hunt) around the ideal level position.

When the lift is about to start (for example in response to a user command via input means), the high and low limits are set. These are based on a nominal “level” which is set during the lift installation. Thus if the lift starts when the seat is not level, the first thing that happens is that the seat will be levelled, even before the carriage has moved very far.

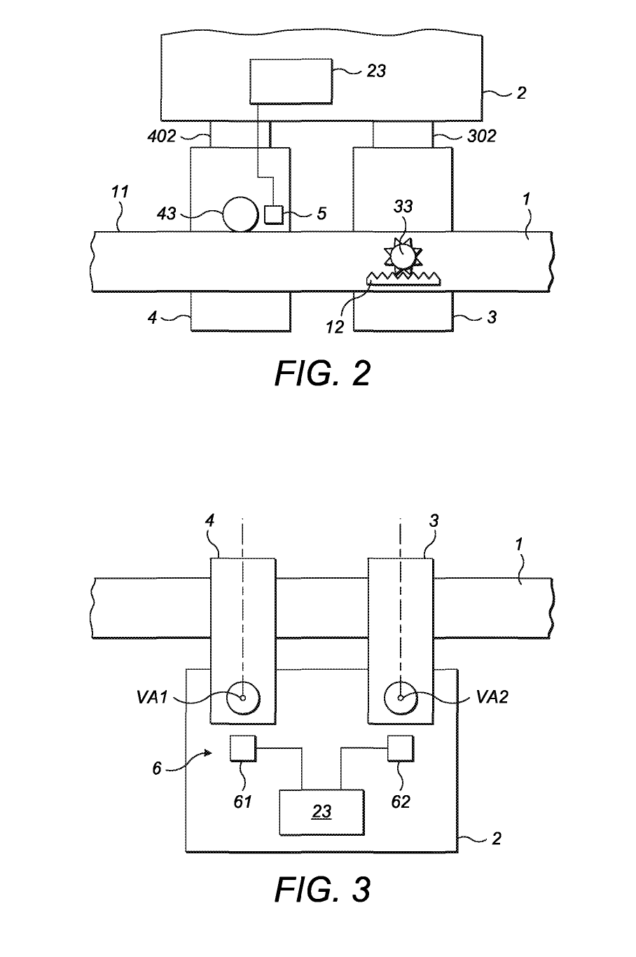

Referring now to FIG. 2, this shows part of a stairlift embodying the invention, with the carriage (2) being located on, and support by, a substantially level portion of track (1). To arrange the seat in a level position the controller (23) has controlled the levelling means to place the support roller (43) in a relatively high position within its range of movement in the levelling bogie (4). The system also comprises slope indicating means in the form of a sensor (5) (which may also be described as a slope sensor). This sensor (5) is arranged to detect that the support role of (43) is at its “level rail” position or at least within a pre-determined range of that position. In certain embodiments the sensor (5) takes the form of a switch having two states, namely a first state when the support roller (43) is away from the “level rail” position, and a second state when the support roller (43) is in the “level rail” position. The sensor (5) provides an output signal to the controller, that output being indicative of whether or not the support roller (43) is in the “level rail” position. The controller responds to this output signal from the sensor (5), which is therefore indicative of the slope or inclination of the section of rail on which the carriage (2) is currently located, and uses that to control the drive means. For example, in certain embodiments the controller is arranged to control the drive means to drive the carriage along the rail at a first speed only when the sensor (5) indicates that the slope of the track is less than a pre-determined amount, and to drive the carriage along the rail at a slower speed when the rail inclination exceeds that pre-determined amount. As will be appreciated, more sophisticated control of drive speed may be employed in alternative embodiments of the invention, and indeed more sophisticated sensors (5) or an array of sensors (5) may be used in order to detect a range of different positions of the support roller (43) indicative of a range of rail inclinations, rather than using a simple sensor giving just an indication of whether rail inclination is less than or greater than a pre-determined amount. In the embodiment of FIG. 2, the carriage (2) is kept level using the sensitive output signal of the first accelerometer, and this ensures that position of the support roller (43) is indicative of current rail inclination. A variety of sensors (5) can be used to provide an indication of support roller position. For example, a sensor could be arranged to measure height of the support roller, or of some other component attached to it, such as a slider-block. In alternative embodiments, an indication of support roller position could be derived from the levelling motor itself, if the control means is arranged to monitor rotor position and number of rotations.

Referring now to FIG. 3, this is a schematic view, from above, of part of a stairlift system embodying the invention. The position of the carriage (2) relative to the rail is such that the level bogie (4) and drive bogie (3) are currently engaging a straight section of rail (1) and are each in their nominal zero degrees position with respect to rotation about vertical axis VA1 and VA2 relative to the carriage assembly (2). It will be appreciated that the view illustrated in FIG. 3 will be the same irrespective of whether the illustrated section of rail is level or inclined. The carriage assembly (2) also comprises curvature indicating means (6) in the form of sensors (61 and 62) arranged to provide signals indicative of the angular position of the level bogie (4) and drive bogie (3) respectively about their vertical axis relative to the carriage (2). These sensors (61 and 62) provide their respective output signals to the controller (23), and the controller uses these output signals as an indication of curvature, in a horizontal plane (or equivalently about a vertical axis) of the portion of rail currently engaged by the bogies (4, 3). As with the slope sensor (5) described above, the sensors (61 and 62) may, in certain embodiments, take simple forms, such as switches having just two states, or in alternative embodiments may be more sophisticated, providing output signals which can be used to distinguish between a large number of different positions or rotations of the bogies relative to the carriage (2). In one embodiment, the sensors (61 and 62) are relative simple switches, actuated only when bogies (4 and 3) are in the “straight rail” position, indicated in FIG. 3. The controller (23) may then be responsive to the switch signals to control drive of the carriage at a relatively high speed only when the switches indicate that the current section of rail is straight, and otherwise the controller may restrict the carriage to be driven at a slower speed or speeds.

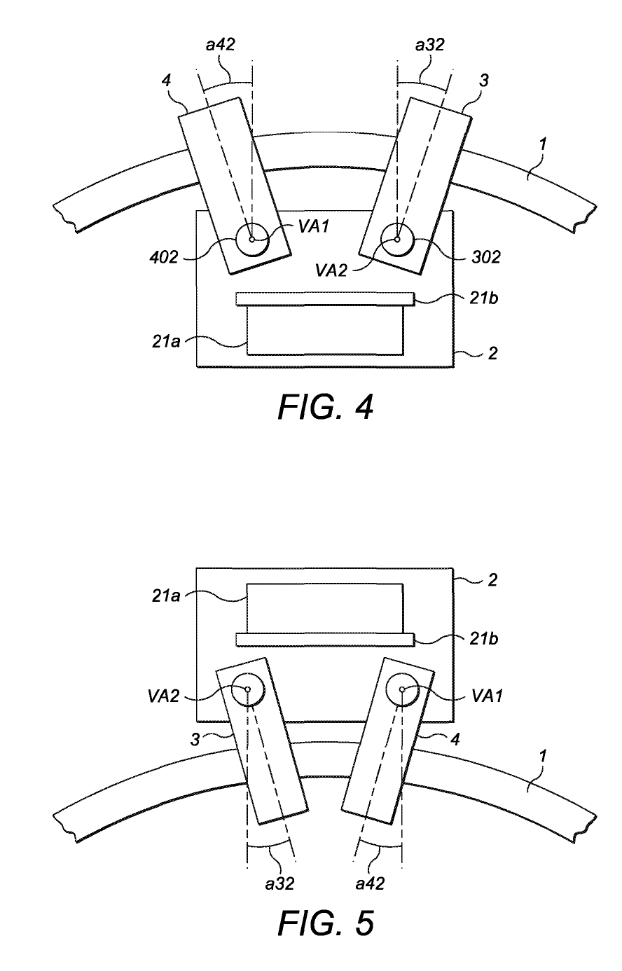

FIG. 4 illustrates the situation when the carriage and bogies of the system of FIG. 3 are negotiating a curved portion of rail, that is a portion having a curved projection on to a horizontal plane. The curved portion in FIG. 4 can be described as an internally curved portion, as the carriage (2) is coupled to the rail via the bogies (4 and 3) so that the seat faces the inside of the curve. The bogies (4 and 3) are adapted such that in order to negotiate this curved rail section they each rotate about their respective vertical axis VA1 and VA2 relative to the carriage (2). Each bogie has been displaced from its nominal zero degrees position by a respective angle (A42 and A32) and these angular displacements are indicative of the current track (i.e. rail) curvature. Generally, the larger these angles, the tighter the curve.

FIG. 5 illustrates the situation where the carriage and bogie assembly of FIGS. 3 and 4 is negotiating an external curve. The bogies have rotated towards each other to accommodate this external curve, in contrast to the situation in FIG. 4 where, to negotiate the internal curve, the bogies (4 and 3) rotated away from each other. Thus, the size and direction of angular displacement of each bogie about its respective rotational coupling axis relative to the carriage assembly (2) is indicative of the degree and direction of track curvature.

It will be appreciated that the views from above shown in FIGS. 3, 4 and 5 will be the same if the respective track sections were level or inclined. Thus, in FIGS. 4 and 5, if the curved track sections were also inclined then the carriage assembly and bogies would be negotiating generally helical paths.

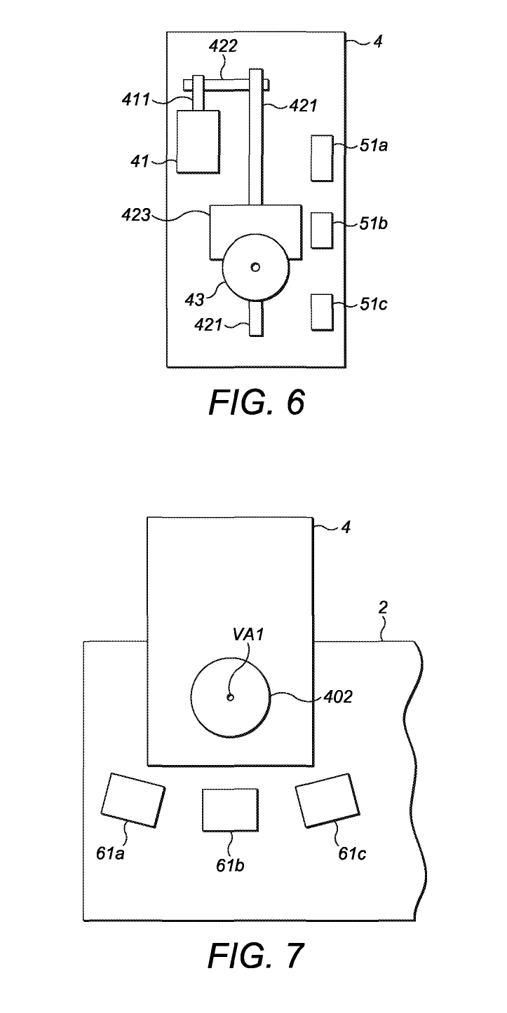

Referring now FIG. 6, this is a schematic representation of part of a stairlift embodying the invention. The illustrated part comprises a level bogie assembly (4) incorporating a plurality of slope detecting sensors (51a, b, c). The level bogie (4) comprises levelling means including a levelling motor (41) arranged to drive a rotatable threaded shaft (421) by means of a drive belt (422). Mounted on the threaded shaft or bar is a slider-block (423), having a corresponding internal thread in a bore through which the shaft (421) passes. The slider-block (423) is arranged such that as the shaft (421) rotates the block (423) moves up or down on the shaft (421), depending on the direction of its rotation. Mounted on the slider-block (423) is a support roller (43). The slope detecting means comprises three separate slope sensors (51a, b, and c), each one being a switch arranged to detect a respective position of the slider-block (423). In other words, which of the switches (51a, b, c) is actuated depends on the vertical position of the slider-block and hence roller (43). Thus, this array of sensors (51a, b, c) is able to distinguish between a plurality of different positions of the support roller, and hence provide the controller with a signal indicative of a plurality of different rail inclinations.

Referring to FIG. 7, this is a schematic representation of part of another stairlift embodying the invention. The illustrated portion comprises a level bogie (4) coupled to a carriage assembly (2) by means of a rotational coupling providing relative rotation about an axis VA1. The carriage assembly (2) also comprises an array of sensors (61a, b, c) which may described as rail curvature sensors, each one detecting a different respective angular position of the bogie (4) relative to the carriage (2).

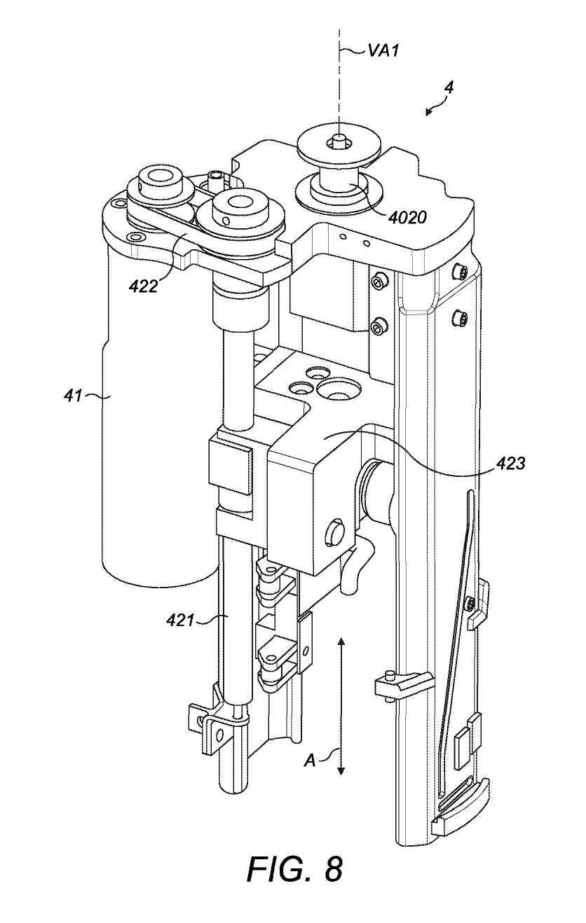

Referring now to FIG. 8, is a more detailed drawing of a level bogie assembly (4) of a stairlift embodying the invention. The assembly includes a bogie pivot (4020) which is adapted for connection to the carriage assembly to provide rotation of the bogie relative to the carriage about the axis VA1. The motor (41) is controllable by the control means to rotate the ball screw (421) which in turn is driven up or down in the direction shown by arrow A. The slider-block (423) carries the support roller.

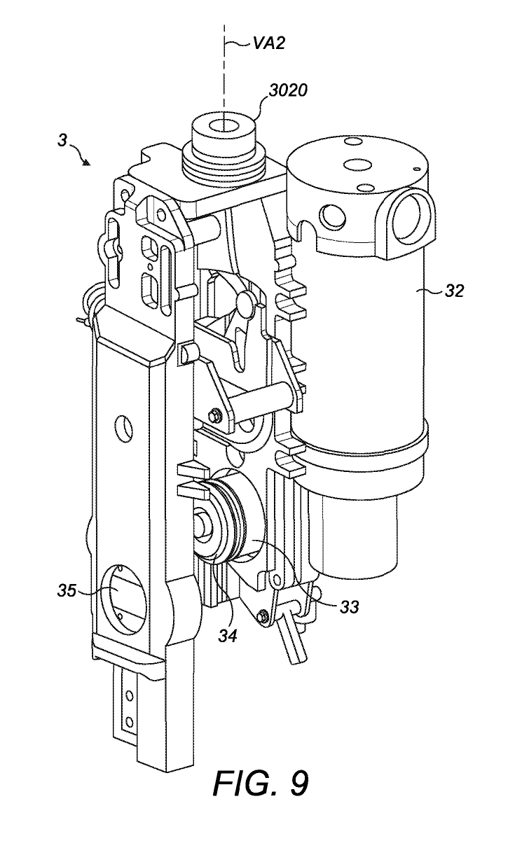

Referring now to FIG. 9, this shows a drive or power bogie assembly (3) of a system embodying the invention. The assembly includes a bogie pivot (3020) adapted for connection to the carriage so that the assembly can rotate with respect to the carriage about axis VA2. A motor and gearbox (43) is controlled by the control means of the carriage to drive a toothed drive pinion (43). The assembly also comprises a support roller (43), and a guide roller (35) each adapted to engage respective surfaces of the rail.

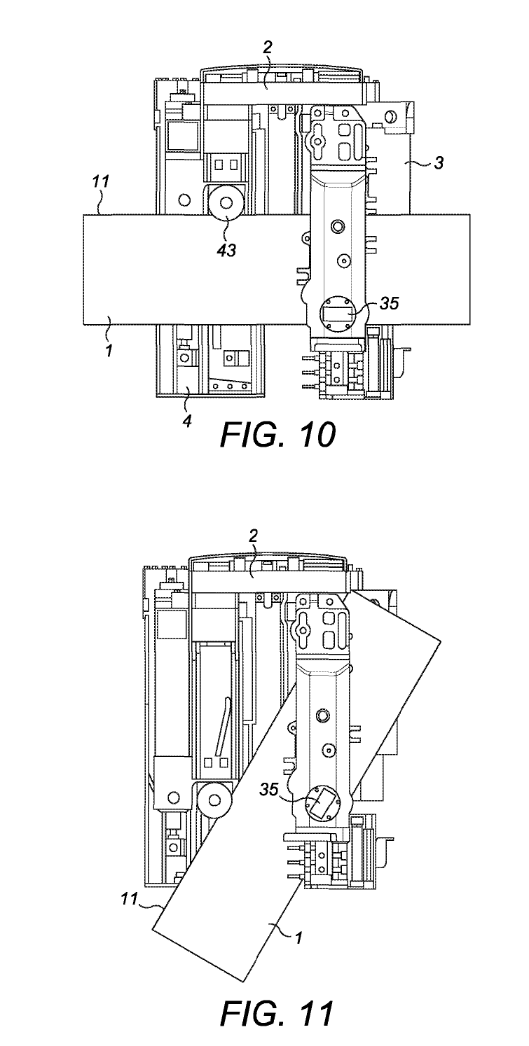

Referring now FIGS. 10 and 11, these show portions of a carriage assembly (2) and power and level bogies (3, 4) of a lift system embodying the invention on different sections of a rail (1). In FIG. 10, the assembly is engaging and is supported by a level section of rail (i.e. a rail substantially at zero degrees), and the support roller (43) of the level bogie has been moved to an upper position such that it supports the carriage (2) in a level position. The guide roller (35) of the power bogie is in its nominal horizontal position, that is with its axis of rotation being substantially vertical.

In FIG. 11, the assembly is shown negotiating a steeply inclined section of rail, in particular a rail inclined at 60 degrees to the horizontal. In order to maintain the carriage (2) level, the level bogie has been controlled to drive the support roller (43) compared with its “level rail” position. The guide roller (35) of the power bogie has also rotated.

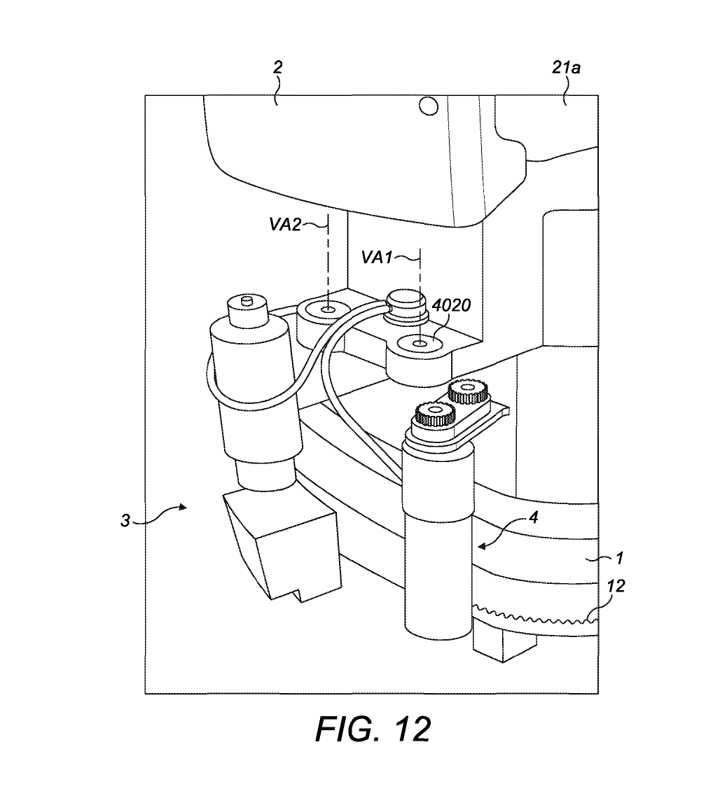

Referring now to FIG. 12, this is a photograph of part of a system embodying the invention, with the carriage (2) and bogies (3 and 4) assembly negotiating a horizontal bend of the rail (1). The toothed rack (12) of the rail (1) can be seen, this rack (12) being engaged by the drive pinion (not visible in the figure). To negotiate this internal bend, the bogies have pivoted apart (i.e. away from each other), each pivoting about its respective axis VA2, VA1.

It will be appreciated that when the carriage and bogies assembly of an embodiment of the invention negotiates a helical bend, the bogies (3 and 4) will rotate about their respective rotational axes and the levelling support roller will be driven away from its “level rail” position (i.e. downwards or upwards, depending on the direction of the slope and the configuration of the levelling mechanism) to maintain the carriage seat substantially at zero degrees with respect to horizontal.

It will be appreciated that, in certain embodiments, the controller is arranged to control the drive means to drive the carriage 2 along the rail at a lower speed when the levelling means is being controlled to respond to a changing track inclination than when the track inclination is constant (zero or non-zero). Thus, the controller may slow the carriage down on segments of the track where the slope is changing, to give the levelling system adequate time to keep the seat (which may also be described as a chair) level, or at least within a specified range around level.

The accelerometer may be a one-axis, two-axis, or three-axis accelerometer, and if a multiple-axis accelerometer is used, one or a plurality of its outputs may be used by the control means. In certain embodiments it is rigidly mounted on a main controller circuit board.

In embodiments employing two accelerometers, the control means may be arranged to immobilise the carriage if their outputs, or signals derived from their outputs, do not agree with each other.

Certain embodiments provide stairlift systems with real-time levelling, based on signals from an accelerometer rigidly mounted on the carriage assembly itself (and hence rigidly mounted with respect to the seat or platform.

Certain embodiments incorporate electronic accelerometers for level detection and control, and sensitive accelerometers of this type may pick up mechanical noise, for example resulting from a drive system using a toothed pinion and track. However, the noisy signals may be processed to yield signals suitable for accurate, real-time levelling control.

For slope and/or curvature detection a variety of sensors may be employed, including simple microswitches arranged to provide indications of when track inclination or track curvature exceed predetermined thresholds (limits). The microswitch signals can be used in speed control, and the arrangement may be fail safe, so that one or more upper speeds are only accessible if the switches are functioning correctly.

The signals from the level detection means and curvature detection means may be used in a variety of ways, for example to slow the carriage down when travelling around external bends, speed it up when negotiating internal bends, slow it down on regions where track inclination is changing etc.

In certain embodiments the main sensor (accelerometer) for levelling control is sampled more than 1000 times a second, and its signal is very noisy (exhibiting large spikes), as a result of mechanical vibrations as the carriage moves. A problem is, therefore, how to use the noisy sensor output for control purposes. The control circuit or controller solves this problem by first taking a number of readings (which may include “extreme” values) from the sensor in a first time interval and calculates an average, and then uses this calculated average to define an acceptable “window” of values for a second measurement period. Next, in this second period, a further plurality of values are taken, but those outside the previously defined window are discarded before an average of the remaining values is taken. This second average value is then used as an indication of level for levelling control purposes.

In certain embodiments the system incorporates a back-up sensor (a second accelerometer) in addition to the main. Only the main sensor signal is used for levelling control (i.e. the signal to the levelling motor is derived from the main sensor alone), but the signal from the back-up sensor is checked for agreement with the main sensor before movement of the carriage is allowed. If the signals do not agree, within specified limits, the carriage is not allowed to move (or is stopped, if it were already in motion). The main sensor is sampled at a high rate (e.g. over 1000 Hz) to derive the levelling control signal, whilst the back-up sensor is sampled at a lower rate (e.g. approximately 100 Hz) for safety-check purposes.

In certain embodiments the levelling system is a closed loop servo that operates in real-time, to ensure that the seat is maintained in a level condition while the carriage (which may also be described as the lift) is moving. It does not rely on memorised level information but instead reads values continuously from a level sensor and feeds those values into a P.I.D. (Proportional, Integral and Derivative position loop) software algorithm that generates direction and speed information for the levelling motor drive. For safety purposes, several parts of the electronic control circuitry are duplicated. Each part has a processor and the two processors have to agree before any lift move can start, and if either part generates an error, then the lift will be stopped immediately, also each processor monitors the activity of the other, and if either one stops operating the lift will stop. There are two level sensors (one for each processor). The circuit board in certain embodiments has provision for several alternative types of level sensors. The level sensors are accelerometers and give an analogue signal that changes according to the level and acceleration of any move. The acceleration part of the signal is filtered out in software to leave the level value as an input to the P.I.D. algorithm. This algorithm calculates proportional, integral and derivative values from the level input, and these three values are then summed to provide a value that represents the direction and speed information for the levelling motor drive. The motor drive is a standard “H” motor drive circuit, that connects one side of the motor to the positive voltage, and then pulses the switch which connects the other side of the motor to the zero voltage. The speed of the motor is directly proportional to the width of the drive pulses.

1. A lift system comprising:
a rail:
a carriage assembly comprising a seat or platform for supporting a person to be conveyed along the rail;
drive means coupled to the carriage assembly and adapted to engage the rail and drive the carriage assembly along the rail; and
levelling means operable to adjust an orientation of the carriage assembly with respect to the rail,
the carriage assembly further comprising:
a first accelerometer arranged to provide an output signal indicative of an inclination of the seat or platform with respect to a horizontal plane; and
control means arranged to receive said output signal and adapted to control the levelling means in response to the output signal to adjust said orientation to maintain the inclination of the seat or platform substantially at a predetermined value or within a predetermined range as the carriage is conveyed along the rail.

2.-4. (canceled)

5. A lift system in accordance with claim 1, wherein the levelling means comprises a levelling motor operable to adjust said orientation.

6. (canceled)

7. A lift system in accordance with claim 1, wherein the control means is arranged to use the accelerometer output signal to generate a controller output signal, and to supply said controller output signal to the levelling motor to control said motor.

8.-9. (canceled)

10. A lift system in accordance with claim 7, wherein the control means is arranged to sample the accelerometer output signal to yield a plurality of sampled values and the control means is further arranged to use the sampled values to generate the controller output signal.

11. (canceled)

12. A lift system in accordance with claim 1, wherein the control means is arranged to generate a plurality of average values from the sampled values, each average value being a value obtained by averaging a respective plurality of the sampled values, the control means being arranged to use the average values to generate the controller output signal.

13. A lift system in accordance with claim 5, wherein each average value is obtained by averaging X sampled values, where X is in the range 20 to 100, and preferably 64.

14. A lift system in accordance with claim 5, wherein the control means is arranged to compare each average value with a first threshold value and with a second threshold value in the process of using the average values to generate the controller output signal.

15. A lift system in accordance with claim 7, wherein the control means is arranged to use a said average value as an indication of inclination if that average value lies outside the range defined by the first and second threshold values.

16. A lift system in accordance with claim 1, wherein the control means is arranged to treat said inclination as being equal to a predetermined constant if that average value lies within said range.

17. A lift system in accordance with claim 7, wherein the control means is adapted to generate the control output signal using a cyclical algorithm having an input parameter, and the control means is adapted to set the input parameter in each cycle of the algorithm to equal the average value corresponding to that cycle if that average value lies outside the range defined by the first and second thresholds, and to equal a constant value if that average value lies inside said range.

18. A lift system in accordance with claim 10, wherein the algorithm is a PID algorithm, the control output signal comprising a first component, proportional to a current error value, a second component, derived from at least one previous error value, and a third component, dependent upon a rate of change of error value, wherein the error value in a particular cycle is equal to the difference between a constant, indicative of a desired inclination, and the average value corresponding to that cycle if that average value lies outside the range defined by the first and second thresholds, and the error value equals zero if that average value lies inside said range.

19. A lift system in accordance with claim 1, wherein the control means is arranged to control the drive means, and the carriage assembly comprises a second accelerometer arranged to provide a second output signal indicative of said inclination, the control means being arranged to receive said second accelerometer output signal and being adapted to use the first and second accelerometer output signals to determine whether or not to control the drive means to drive the carriage assembly along the rail.

20. A lift system in accordance with claim 12, wherein the control means is arranged to sample the second accelerometer output signal to yield a plurality of second sampled values.

21. A lift system in accordance with claim 13, wherein the control means is arranged to sample the second accelerometer output signal at a lower rate than the first accelerometer output signal.

22. A lift system in accordance with claim 13, wherein the control means is arranged to sample the second accelerometer output signal at a rate of R2 samples per second, where R2 is in the range 50 to 200, and preferably 100.

23. A lift system in accordance with claim 13, wherein the control means is arranged to generate a second average value from the second sampled values, the second average value being a value obtained by averaging a respective plurality of the second sampled values, the control means being arranged to compare the second average value with an average value obtained from the first accelerometer output signal and to prevent the drive means from driving the carriage assembly along the rail if the compared values differ by more than a predetermined amount.

24. A lift system in accordance with claim 16, wherein the second average value is obtained by averaging Y sampled values, where Y is in the range 20 to 100, and preferably 64.

25. A lift system in accordance with claim 1, wherein the control means is arranged to control the drive means, and the system further comprises at least one of:
slope indicating means arranged to provide the control means with at least one signal indicative of a slope of a portion of rail on which the carriage assembly is currently located; and
curvature indicating means arranged to provide the control means with at least one signal indicative of a horizontal component of curvature of the portion of the rail on which the carriage assembly is currently located,
and wherein the control means is adapted to use at least one of said signals indicative of slope or curvature to control a speed at which the drive means drives the carriage assembly along the rail according to position along the rail.

26.-28. (canceled)

29. A lift system in accordance with claim 18, wherein the levelling means comprises:
a support roller adapted to engage the rail and support the carriage assembly on the rail; and
means for adjusting a vertical position of the support roller relative to the carriage assembly,
and wherein the at least one signal indicative of a slope comprises at least one signal indicative of the vertical position of the support roller relative to the carriage assembly.

30. A lift system in accordance with claim 19, wherein the slope indicating means comprises at least one switch having a state dependent upon the vertical position of the support roller relative to the carriage assembly.

31.-39. (canceled)

40. A method of operating a lift system comprising a rail, a carriage assembly comprising a seat or platform for supporting a person to be conveyed along the rail, drive means coupled to the carriage assembly and adapted to engage the rail and drive the carriage assembly along the rail, and levelling means operable to adjust an orientation of the carriage assembly with respect to the rail, the method comprising:
arranging a first accelerometer in the carriage assembly to provide an output signal to control means, the output signal being indicative of an inclination of the seat or platform with respect to a horizontal plane; and
operating the control means to control the levelling means in response to the output signal to adjust said orientation to maintain the inclination of the seat or platform substantially at a predetermined value or within a predetermined range as the carriage is conveyed along the rail.

41. A lift system comprising:
a rail:
a carriage assembly comprising a seat or platform for supporting a person to be conveyed along the rail;
drive means coupled to the carriage assembly and adapted to engage the rail and drive the carriage assembly along the rail;
control means arranged to control the drive means;
slope indicating means arranged to provide the control means with at least one signal indicative of a slope of a portion of the rail on which the carriage assembly is currently located; and
curvature indicating means arranged to provide the control means with at least one signal indicative of a horizontal component of curvature of the portion of the rail on which the carriage assembly is currently located,
and wherein the control means is adapted to use at least one of said signals indicative of slope or curvature to control a speed at which the drive means drives the carriage assembly along the rail according to position along the rail.

42.-46. (canceled)

47. A lift system in accordance with claim 22, further comprising:
levelling means operable to adjust an orientation of the carriage assembly with respect to the rail; and
inclination indicating means arranged to provide an output signal indicative of an inclination of the seat or platform with respect to a horizontal plane,
the control means being arranged to receive said output signal and adapted to control the levelling means in response to the output signal to adjust said orientation to maintain the inclination of the seat or platform substantially at a predetermined value or within a predetermined range as the carriage is conveyed along the rail.

48. A lift system in accordance with claim 23, wherein the levelling means comprises:
a support roller adapted to engage the rail and support the carriage assembly on the rail; and
means for adjusting a vertical position of the support roller relative to the carriage assembly,
and wherein the at least one signal indicative of a slope comprises at least one signal indicative of the vertical position of the support roller relative to the carriage assembly.

49. A lift system in accordance with claim 24, wherein the slope indicating means comprises at least one switch having a state dependent upon the vertical position of the support roller relative to the carriage assembly.

50.-52. (canceled)
